(19) United States
(12) Patent Application Publication
(10) Pub. No.: US 2004/0192349 A1
(43) Pub. Date: Sep. 30, 2004

(54) Wireless communication device

(76) Inventor: Paul E Reilly, Cambridge (GB)

Correspondence Address: William M Lee, Barnes & Thornburg, P O Box 2786, Chicago, IL, 60690-2786, US

(21) Appl. No.: 10/486,942

(22) PCT Filed: Aug. 16, 2002
(86) PCT No.: PCT/GB02/03775

(30) Foreign Application Priority Data
Aug. 16, 2001 (GB) 0119934.8

(51) Int. Cl. H04Q 7/20

(52) U.S. Cl. 455/456.2

(57) ABSTRACT

Disclosed is a wireless communication device adapted to receive a radio frequency signal containing a uniform resource identifier (URI) specifying a location of content on a server of an Internet content provider. The device is operable to transmit the URI to the server via a mobile telephone network and receive content transmitted by the server in response to reception of the URI, and to generate a GUI of which a frame includes a selectable image element representative of the Internet content provider. Also disclosed is a computer program executable by such a wireless communication device to cause the device, in response to reception of a URI, to generate a GUI of which a frame includes a selectable element representative of an Internet content provider.

### FIELD OF THE INVENTION

The present invention relates to a wireless communication device operable to receive a uniform resource identifier (URI) specifying a location of content on a server of an Internet content provider, to transmit the URI to the server via a mobile telephone network and to display content transmitted via the mobile telephone network by the server, and to a computer program for controlling the operation of such a device.

### BACKGROUND TO THE INVENTION

Wireless communication devices such as mobile telephone handsets or personal digital assistants are increasingly commonly provided with a short-range radio frequency (rf) transceiver in addition to the long-range rf transceiver used to communicate with a mobile telephone network. The short-range transceiver provides a wireless interface between a device and nearby peripheral equipment such as a printer or a wireless headset.

Bluetooth is a short-range wireless specification that has been developed to implement the wireless interface.

It has been proposed that the wireless interface could be used to receive content, typically text and graphics data, transmitted by providers of goods and services, the content advertising their goods and services. It is envisaged that a provider of goods and services would use a short-range rf transmitter at the location at which the goods and services are provided, such that only wireless communication devices within a convenient distance of the location at which the goods and services are provided would receive the content. A user of a wireless communication device would be alerted to the receipt of such content by a ring tone and the content would be displayed on a display screen of the device. The user would then decide whether the displayed goods and services were of interest before deleting the content.

Examples of providers of goods and services include an owner of a shop or restaurant who may wish to advertise special offers and a rail or coach operator who may wish to publicise fares and timetables.

It has been predicted that such a system, while extremely attractive to providers of goods and services, would for the most part be intrusive and irritating to users of wireless communication devices, because in most cases the goods and services would not be of interest to the users. It has therefore further been predicted that, where possible, most users would disable this feature, preventing them from obtaining content advertising goods and services that would be of interest to them.

### SUMMARY OF THE INVENTION

According to a first aspect of the invention there is provided a wireless communication device that has generating means operable to generate a graphical user interface (GUI) comprising a plurality of frames, of which at least one frame contains a selectable image element, the device also having a display screen operable to display a frame of the GUI, and input means operable by a user of the device to select a selectable image element from a frame displayed by the display screen, the device being adapted to receive a radio frequency (rf) signal containing a content uniform resource identifier (URI) specifying a location of content on a server of an Internet content provider, and being operable to transmit the content URI to the server via a mobile telephone network, and to receive the content, which is transmitted by the server via the mobile telephone network in response to receipt of the content URI, characterised in that the generating means is operable, in response to reception by the device of the rf signal containing the content URI, to generate a GUI of which one of the frames includes a selectable image element representative of the Internet content provider.

The invention therefore provides a wireless communication device that enables providers of goods and services in the vicinity of the device to supply content relating to those goods and services to a user of the device in a non-intrusive fashion, since the selectable image element representative of the Internet content provider, which will generally be identifiable with the provider of the goods and services, will be displayed on the device only if the user of the device causes the device to display the frame of the GUI that includes the selectable element representative of the Internet content provider. Moreover, the invention provides a wireless communication device that enables a provider of goods and services in the vicinity of the device to supply a large amount of content relating to those goods and services to a user of the device via the existing infrastructure of the Internet, while the provider of goods and services has only to transmit a content URI to the device.

The device may advantageously be operable, in response to selection of the selectable image representative of the Internet content provider, to transmit the content URI to the server and to display at least a portion of the content transmitted by the server on the display screen.

The time taken to transmit the content URI to the server and for the server to transmit the content to the device means results in an appreciable delay between selection of the selectable image element and display of the content on the display screen.

The device may, therefore, advantageously be operable, in response to reception of the rf signal containing the content URI, to transmit the content URI to the server, and in response to selection of the selectable image element representative of the Internet content provider, to display at least a portion of the content on the display screen.

In this way, since the content is received by the device shortly after reception of the rf signal containing the content URI, when the selectable image element is selected, there is generally no appreciable delay between selection of the selectable image element and display of the content on the display screen.

In a preferred embodiment of the invention the display screen is a touch sensitive liquid crystal display screen and selection of the selectable image element is by touching a portion of the display screen on which the element is displayed. Alternatively, selection of the element could be by means of a conventional cursor navigation system, in which a cursor displayed on a display screen is placed over the element and a “select” button pressed.

It is also envisaged that a mobile telephone service operator could transmit the rf signal containing the content URI to the device via the mobile telephone network on behalf of a provider of goods and services, in response to determination that the device is within a particular geographic area in the vicinity of the provider of goods and services.

Preferably, therefore, the device has location means operable to determine a geographical location of the device, and the device is operable periodically to transmit location data specifying a geographical location of the device to a mobile telephone service operator via the mobile telephone network, and to receive a content URI specifying a location of content on a server of an Internet content provider, which is transmitted via the mobile telephone service operator if the location data indicate that the geographical location of the device is within a particular geographical area.

Preferably the location means comprises a global positioning system receiver.

Preferably the device is adapted to receive an rf signal containing a content URI from a short-range rf transmitter operating in accordance with the Bluetooth specification.

The device may advantageously be adapted to receive content from the server in the form of World Wide Web pages and have browser means operable to browse the World Wide Web pages.

The device may advantageously have loudspeaker means and be operable to cause the loudspeaker means to generate an audio signal from at least a portion of the content.

The device may advantageously be adapted to receive an rf signal containing GUI customisation data associated with the content URI, the GUI customisation data comprising one or more of graphics data, text data, audio data, HTML script, boundary data specifying a geographical area, and executable code. Typically the GUI customisation data is transmitted in the same rf signal as the content URI.

Alternatively or additionally, the device may advantageously be adapted to receive an rf signal containing a GUI customisation data URI specifying a location on the server of the Internet content provider of GUI customisation data, the GUI customisation data comprising one or more of graphics data, text data, audio data, HTML script, boundary data specifying a geographical area, and executable code. Typically the GUI customisation data URI is transmitted in the same rf signal as the content URI.

The generating means may advantageously be operable to generate a GUI that includes the graphics and/or text data. A provider of goods and services is thus able to modify the GUI of a device, for example by incorporating a banner containing the name of his enterprise into the GUI.

The selectable image element representative of the Internet content provider may be the content URI itself, for example

www. supermarket.co.uk/cambridge/pinkstreet/special_offers.html.

Preferably the generating means is operable to generate a GUI of which the selectable image element representative of the Internet content provider includes at least a portion of the graphics and/or text data. Instead of the content URI itself in the above example, the selectable image element might be a name of a supermarket operator and/or a representation of a device used by the supermarket operator. A provider of goods and services is thus able to modify the selectable image element representative of the Internet content provider, for example by replacing the selectable image element by a logo identifiable as representative of his enterprise, to encourage the user to select the selectable image element to obtain the content relating to the provider's goods and services.

Where the device includes loudspeaker means, the device may advantageously be operable to cause the loudspeaker means to generate an audio signal from the audio data. The audio signal might be a spoken message advertising the goods and services of, or a jingle associated with, the Internet content provider, which is reproduced when the frame of the GUI that includes the selectable element representative of the Internet content provider is displayed on the display screen.

The input means may advantageously include a softkey, that is a key the function of which may be temporarily redefined by a user of the device, and the device may advantageously be operable to modify the function of the softkey in accordance with at least a portion of the HTML script. In this way, the device can be made to transmit the content URI in response to operation of the softkey, rather than by selection of the selectable image element representative of the Internet content provider.

The boundary data specifies a geographical area in the vicinity of the provider of goods and services.

The device may advantageously comprise processing means operable to execute the executable code. The executable code might, for example, cause the selectable image element representative of the Internet content provider to be animated.

The device may advantageously be adapted to receive an rf signal containing user preference data associated with the content URI, to compare the user preference data with a user preference profile stored in the device, to generate a user interest value associated with the content URI, and to cause the generating means to generate the GUI of which one of the frames includes a selectable image element representative of the content only if the user interest value exceeds a threshold value stored in the device.

In this way the user of the device can select the types of goods and services in response to receipt of a content URI from the providers of which the device will cause the generating means to include the selectable image element representative of the Internet content provider in the GUI.

The device may advantageously be operable to cause the generating means to remove the selectable image element representative of the Internet content provider from the GUI and to discard the content URI and to carry out any of the following actions: cause the generating means to remove the graphics and/or text data from the GUI and to discard the GUI customisation data URI, GUI customisation data and/or user interest value associated with the content URI in response to any of the following: when a time elapsed since the device received the rf signal containing the content URI exceeds a threshold value, when the location means determines that the device is in a geographic area outside that specified by the boundary data, when the user interest value associated with the content URI is less than at least one other user interest value associated with another content URI, and when a selectable image element representative of an instruction to delete the content URI is selected.

The device may therefore remove the selectable image element representative of the Internet content provider from the GUI so as to prevent the frame that includes the selectable image element from becoming overcrowded with selectable image elements. While the device is in the vicinity of the provider of goods and services, it will periodically receive rf signals containing the content URI for as long as it is within range of the short-range rf transmitter. If the device does not receive the content URI again after a certain interval, then the device must have moved out of range of the transmitter, and hence out of the vicinity of the provider of goods and services, and the selectable image element may be deleted from the GUI. Where the device includes location means the determination that the device is out of the vicinity of the provider of goods and services may be accomplished by comparison of the geographical location of the device from the location means and the boundary data in the GUI customisation data.

If the frame of the GUI that contains the selectable image element representative of the Internet content provider becomes full of image elements, or the device is unable to store any more content URIs, the device can determine whether to accept a new content URI and delete a stored content URI, or to reject the new content URI, by comparing the user interest values associated with the stored content URIs and the new content URI. Alternatively, the content URIs can be manually deleted by the user of the device.

Where the device includes location means the device may advantageously be operable to cause the generating means to remove the selectable image element representative of the Internet content provider from the GUI and to discard the content URI and to carry out any of the following actions: cause the generating means to remove the graphics and/or text data from the GUI and to discard the GUI customisation data URI, GUI customisation data and/or user interest value associated with the content URI in response to reception of an rf signal containing a delete instruction transmitted via the mobile telephone network by the mobile telephone network operator if the location data indicate that the geographical location of the device is outside a particular geographical area.

Alternatively or additionally the device may be operable to delete one or more content URIs in response to the number of content URIs stored in the device, or number of selectable image elements representative of Internet content providers displayed in the GUI, exceeding a threshold value.

According to a second aspect of the invention there is provided a computer program executable by a wireless communication device, the program comprising instructions to cause the device to generate a GUI comprising a plurality of frames and to display one of the frames, to cause the device to determine whether an rf signal received by the device contains a content URI specifying a location of content on a server of an Internet content provider, and to transmit the content URI via a mobile telephone network to the server, characterised in that the program further comprises instructions to cause the device to generate a GUI of which one of the frames includes a selectable image element representative of the Internet content provider.

The program may advantageously further comprise instructions to cause the device, in response to selection of the selectable image element representative of the Internet content provider, to transmit the content URI to the server and to display at least a portion of content transmitted to the device via the mobile telephone network by the server in response to reception of the content URI.

Alternatively or additionally, the program may advantageously further comprise instructions to cause the device to transmit the content URI in response to receipt of the rf signal containing the content URI and, in response to selection of the selectable image element representative of the Internet content provider, to display at least a portion of content transmitted to the device via the mobile telephone network by the server in response to receipt of the content URI.

The program may advantageously further comprise instructions to cause the device periodically to transmit location data specifying a geographical location of the device via the mobile telephone network to a mobile telephone service operator, and to determine whether an rf signal, which is transmitted via the mobile telephone network by the mobile telephone service operator, contains a content URI.

Preferably the program further comprises instructions to cause the device to determine whether an rf signal received by the device contains GUI customisation data associated with the content URI, the GUI customisation data comprising one or more of graphics data, text data, audio data, HTML script, boundary data specifying a geographical area, and executable code.

Alternatively or additionally the program may advantageously further comprise instructions to cause the device to determine whether an rf signal received by the device contains a GUI customisation data URI specifying a location on the server of GUI customisation data associated with the content URI, the GUI customisation data comprising one or more of graphics data, text data, audio data, HTML script, boundary data specifying a geographical area, and executable code, and to cause the device to transmit the GUI customisation data URI to the server via the mobile telephone network.

Preferably the program further comprises instructions to cause the device to generate a GUI that includes the graphics and/or text data.

Preferably the program further comprises instructions to cause the device to generate a GUI of which the selectable image element representative of the Internet content provider includes at least a portion of the graphics and/or text data.

Preferably the program further comprises instructions to cause the device to modify the function of a softkey in accordance with at least a portion of the HTML script.

Preferably the program further comprises instructions to cause the device to execute the executable code.

Preferably the program further comprises instructions to cause the device to determine whether an rf signal received by the device contains user preference data associated with the content URI, to cause the device to compare the user preference data with a user preference profile stored in the device, generate a user interest value associated with the content URI, and to cause the device to generate the GUI that includes the selectable image element representative of the Internet content provider only if the user interest value exceeds a threshold value stored in the device.

Preferably the program further comprises instructions to cause the device to remove the selectable image element representative of the Internet content provider from the GUI, to discard the content GUI and to carry out any of the following actions: cause the device to remove the graphics and/or text data from the GUI and to discard the GUI customisation data URI, GUI customisation data and/or user interest value associated with the content URI in response to any of the following: when a time elapsed since the device received the rf signal containing the content GUI exceeds a threshold value, when the location means determines that the device is in a geographic location outside the geographic area specified by the boundary data, when the user interest value associated with the content URI is less than at least one other user interest value associated with another URI, and when a selectable image element representative of an instruction to deleted the URI is selected.

Where the program includes instructions to cause the device periodically to transmit location data to a mobile telephone service operator via the mobile telephone network, the program may advantageously further comprise instructions to cause the device to remove the selectable image element representative of the Internet content provider from the GUI, to discard the content URI and to carry out any of the following actions: cause the device to remove the graphics and/or text data from the GUI and discard the GUI customisation data URI, GUI customisation data and/or user interest value associated with the content URI in response to reception by the device of a delete instruction transmitted via the mobile telephone network by the mobile telephone service operator if the location data indicate that the geographical location of the device is outside a particular geographical area.

The computer program may advantageously be stored on a data carrier.

The invention also lies in a computer program in accordance with the second aspect of the invention when stored on a wireless communication device.

The various aspects of the invention will now be described in greater detail by way of illustrative examples and with reference to the accompanying drawings, in which:

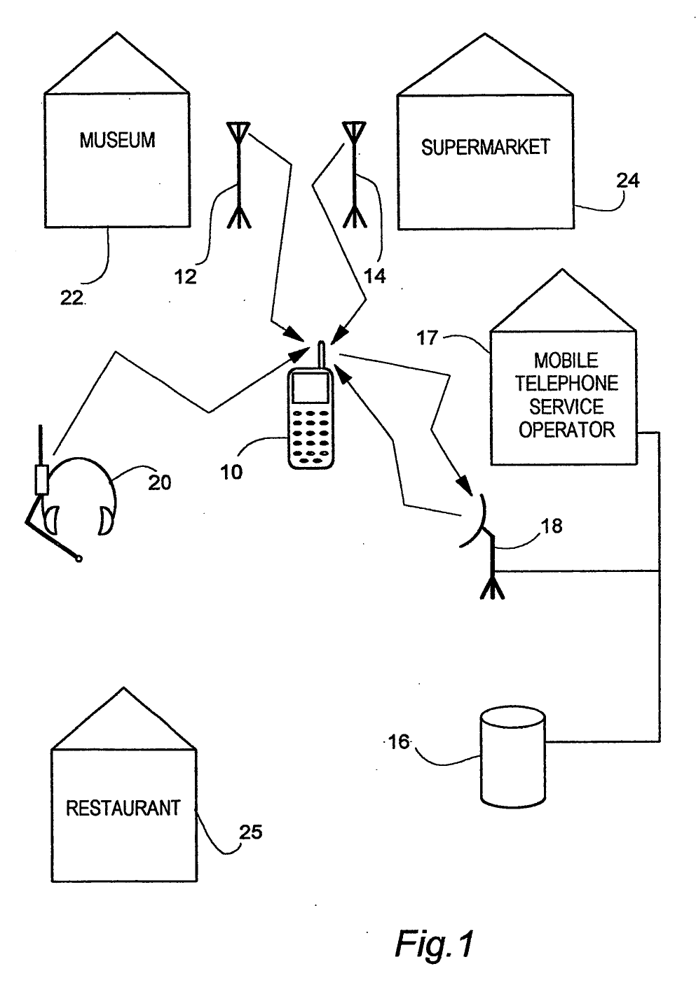

FIG. 1 is a schematic diagram of an illustrative data communication system including a mobile telephone in accordance with the first aspect of the invention;

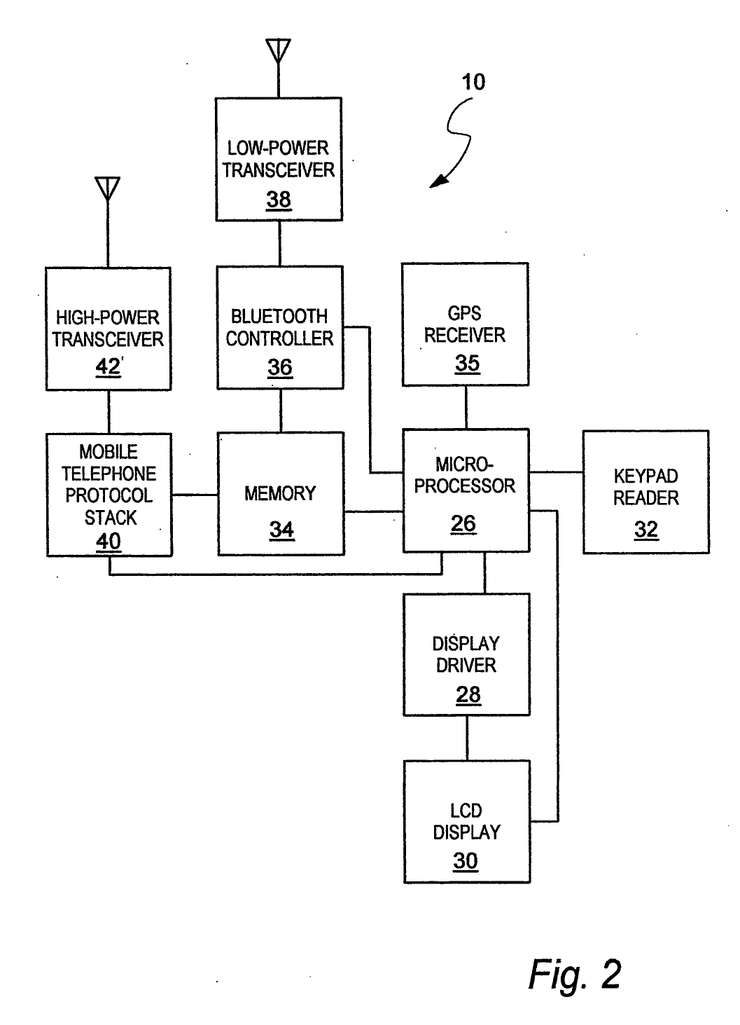

FIG. 2 is a block diagram of the main components of the mobile telephone of FIG. 1;

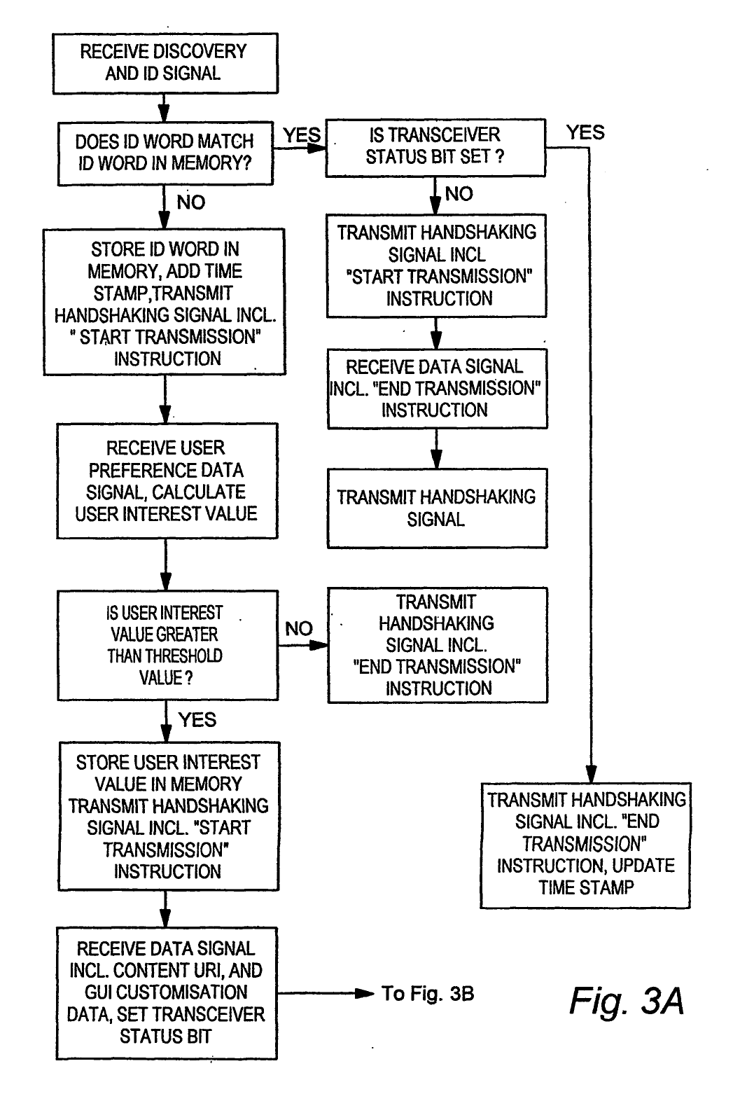

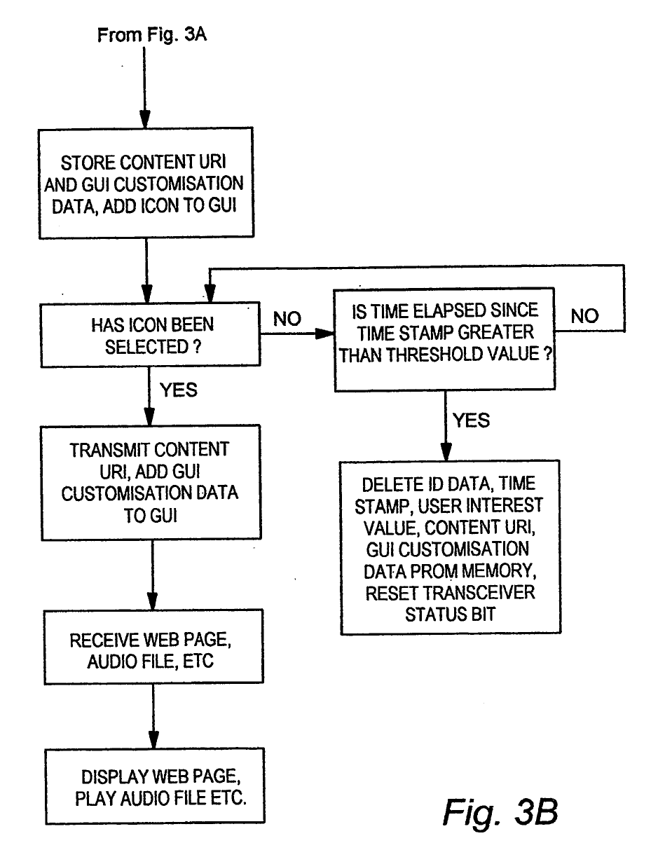

FIGS. 3A and 3B are connected flow diagrams showing the operation of the mobile telephone under the control of a first computer program in accordance with the second aspect of the invention;

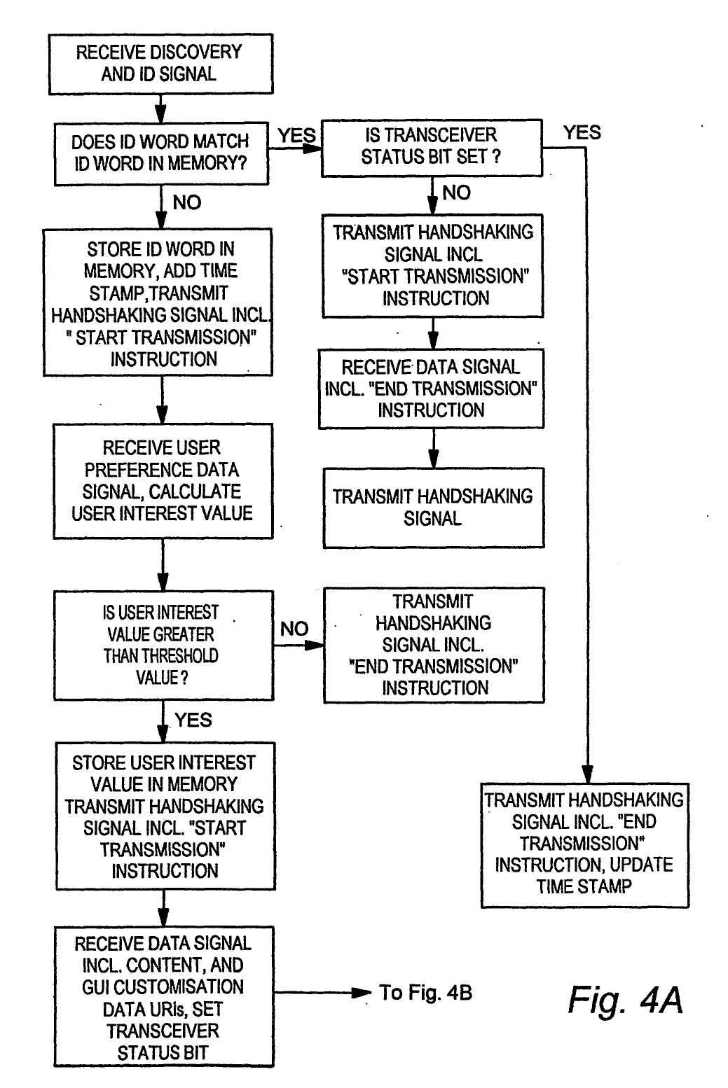

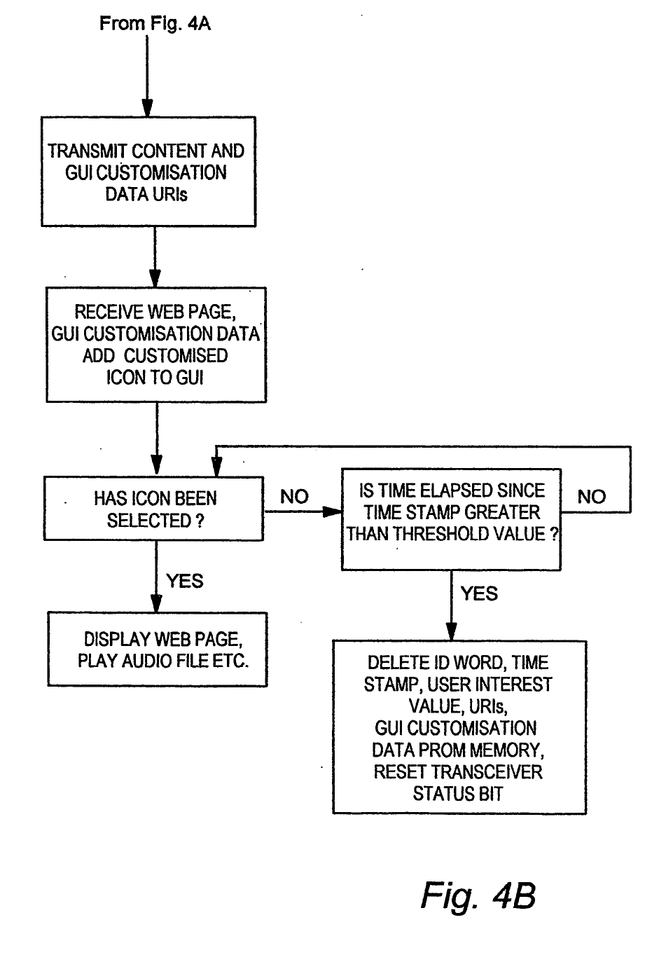

FIGS. 4A and 4B are connected flow diagrams showing the operation of the mobile telephone under the control of a second computer program; and

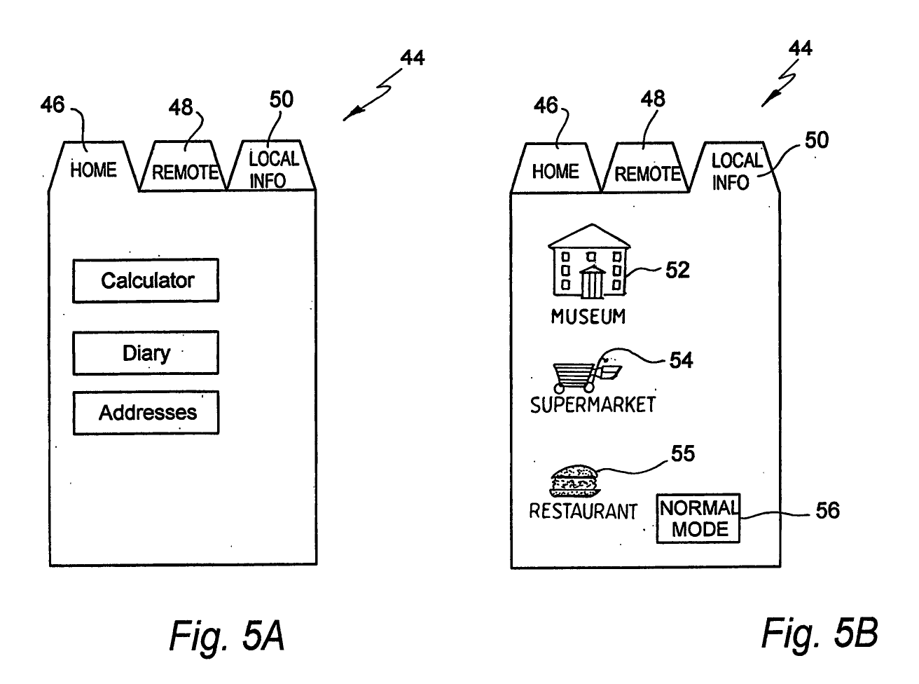

FIGS. 5A and 5B are representations of the graphical user interface of the mobile telephone of FIGS. 1 and 2.

### DETAILED DESCRIPTION OF AN EMBODIMENT

The illustrative data communication system of FIG. 1 comprises a mobile telephone 10 in accordance with the first aspect of the invention, low-power Bluetooth radio frequency (rf) transceivers 12 and 14, a server 16 of an Internet content provider, a mobile telephone service operator 17, a high-power rf transceiver 18 that forms part of a mobile telephone network (not shown), and a wireless mobile telephone headset 20 that has a low-power Bluetooth rf transceiver. The low-power transceivers 12 and 14 are located in the vicinity of, and operable to transmit a content URI specifying the location on the server 16 of data relating to a museum 22 and a supermarket 24 respectively. The server 16 is linked to the high-power transceiver 18 by the mobile telephone network, as is the mobile telephone service operator 17. A restaurant 25 is located in the neighbourhood of the museum 22.

As shown in FIG. 2, the mobile telephone 10 comprises a microprocessor 26, hereafter referred to as “the processor”, a display driver 28 for driving a touch-sensitive liquid crystal display (lcd) screen 30, an alphanumeric keypad (not shown) read by a keypad reader 32, a memory 34, a global positioning system (GPS) receiver 35, a Bluetooth controller 36 for controlling a low-power Bluetooth rf transceiver 38, and a mobile telephone protocol stack 40 for controlling a high-power rf transceiver 42.

The memory 34 stores an operating system comprising first and second computer programs in accordance with the second aspect of the invention. The memory also stores a user preference profile and a user interest threshold value, both of which may be determined by a user of the telephone.

The low-power transceiver 38 is operable to receive rf signals transmitted in accordance with the Bluetooth specification by the low-power transceivers 12 and 14 and wireless headset 20. The transceivers 12 and 14 and that of the wireless headset 20 periodically transmit discovery and identification signals comprising an identification data word that uniquely identifies the transceiver in question. The memory 34 is operable to store a large number of identification data words, each corresponding to a low-power transceiver. The memory is further operable to store, for each identification word, a corresponding transceiver status bit, user interest value, time stamp, content URI, user interface customisation data and content received from the server 16.

The processor sets the transceiver status bit when the telephone receives a content URI from the corresponding low-power transceiver. This enables the processor to distinguish between discovery and identification signals from low-power transceivers such as 12 and 14, and from low-power transceivers of peripheral equipment such as the wireless headset 20, and to disregard transmissions from low-power transceivers such as 12 and 14 if the telephone has already received a content URI from the transceiver, without affecting the flow of data to and from peripheral equipment.

The user interest value is described in greater detail below.

The time stamp corresponding to an identification data word records the time at which the identification data word was last received by the telephone. The corresponding time stamp is therefore updated each time the telephone receives a discovery and identification signal from a low-power transceiver. The low-power transceivers periodically transmit discovery and identification signals and the processor can therefore determine that the telephone has passed out of range of a particular low-power transceiver if the time elapsed since the value of the corresponding time stamp exceeds a threshold value. The processor is then able to determine whether the identification data word should be deleted. Deletion of an identification word before the telephone is out of range of the corresponding transceiver would be pointless, as the identification word would simply be stored again when the transceiver next transmitted a discovery and identification signal.

The mobile telephone of FIGS. 1 and 2 has two modes of operation, namely a first, default mode of operation of the telephone, and a second, selectable mode. The GUI includes a selectable image element that may be selected by a user of the telephone to cause the processor to toggle between execution of the first or second computer program, causing the telephone to toggle between the default and selectable modes of operation.

The operation of the telephone 10 in the default mode will now be described with reference to FIGS. 1 and 2.

The telephone 10 is brought into receiving range of the low-power transceiver 12, which periodically transmits discovery and identification signals. The low-power transceiver 38 of the telephone receives a discovery and identification signal, including an identification word. The processor compares the identification data word with the identification data words stored in the memory and finds no match, because the telephone has not previously received a discovery and identification signal from transceiver 12, and so stores the identification word in the memory 34, stores the time of reception of the identification data word in the corresponding time stamp and causes the transceiver 38 to transmit a handshaking signal including a “start transmission” instruction.

Had the identification data word matched one of the words stored in the memory, the processor would have determined whether the corresponding transceiver status bit was set. If the bit were set, indicating that the telephone had previously received a content URI from the low-power transceiver 12, the processor would have caused the telephone to transmit a handshaking signal including an “end transmission” instruction. If, on the other hand, the bit were reset, indicating that the corresponding transceiver was that of an item of peripheral equipment, the processor would have caused the telephone to transmit a handshaking signal including a “start transmission” instruction.

The low-power transceiver 12 receives the handshaking signal and “start transmission” instruction and transmits a data signal comprising a user preference data word and content URI, the content URI being www.museum.co.uk/info.html. The user preference data word comprises n bits, which correspond to n categories of interest, such as sport, finance, history, entertainment, travel, shopping and news. The categories into which the goods and services of the museum fall are represented by set bits in the user preference data word. The user preference profile stored in the memory of the telephone also comprises n bits corresponding to the same categories of interest as in the user preference data word. The user preference profile is determined by the user of the telephone, who chooses those of the n categories which are of interest to him, which categories of interest are represented by set bits in the user preference profile.

The telephone receives the data signal and the processor identifies the user preference data word and content URI. Having identified the content URI the processor sets the corresponding transceiver status bit and compares the user preference data word with the user preference profile stored in the memory. The processor determines the number of corresponding bits in the user preference data word and user preference profile word that are both set to generate a user interest value corresponding to the identification word. The user interest value is compared with the user interest threshold value selected by the user of the device, and is determined to be greater than the user interest threshold value. The processor therefore causes the memory 34 to store the user interest value and content URI and causes the transceiver 38 to transmit a handshaking signal including a “start transmission” instruction.

If the processor had determined that the user interest value was less than the user interest threshold value, the user preference data and content URI would have been deleted and the transceiver caused to transmit a handshaking signal including an “end transmission” instruction.

The transceiver 12 receives the “start transmission” instruction and transmits a data signal comprising user interface customisation data including text and graphics data. The telephone receives the user interface customisation data from which the processor generates an icon comprising an image of the museum and the word “museum”, which is displayed in the GUI. Had there been no user interface customisation data to transmit, since this is an optional feature, the transceiver 12 would simply have transmitted a handshaking signal including an “end transmission” instruction.

The user selects the icon in the GUI by tapping on the touch-sensitive screen 30 and the processor causes the high-power transceiver 42 to transmit the content URI.

The high-power transceiver 18 receives the content URI, which is transmitted to the server 16 by the mobile telephone network. The server transmits the web page specified by the content URI, which is a general information page from the museum's website, to the transceiver 18 via the mobile telephone network, and the transceiver 18 transmits the web page, which is received by the high-power transceiver 42 of the telephone. The memory 34 stores a browser program that is operable to browse the web page. Retrieval of subsequent web pages, for example as a result of the user selecting a content URI embedded in the general information web page, is carried out between the high-power transceivers 18 and 42 in a manner well known in the field of the wireless Internet.

The above process is shown as a flow diagram in FIGS. 3A and 3B.

The operation of the telephone 10 in the selectable mode will now be described with reference to FIGS. 1 and 2.

The telephone 10 is brought into receiving range of the low-power transceiver 14, which also periodically transmits discovery and identification signals. The telephone receives a discovery and identification signal including an identification data word, which the processor compares with the identification words in the memory 34. The procesor finds no match so stores the identification word in the memory, stores the time of reception of the identification data word in the time stamp and causes the transceiver 38 to transmit a handshaking signal including a “start transmission” instruction.

In response to the “start transmission” instruction the rf transceiver 14 transmits a data signal comprising a user preference data word, content URI and GUI customisation data URI, the content URI being www.supermarket.co.uk/special_offers.html.

The telephone receives the data signal and the processor identifies the user preference data word, content URI and GUI customisation data URI. The processor sets the corresponding transceiver status bit and generates the user interest value from the user preference data word. The user interest value is greater than the user interest threshold value, so the processor causes the memory to store the user interest value and causes the low-power transceiver 38 to transmit a handshaking signal including a “start transmission” instruction, and the high-power transceiver 42 to transmit the content and GUI customisation data URIs.

In response to the “start transmission” instruction, the transceiver 14 transmits a handshaking signal include an “end transmission” instruction, since the GUI customisation data is to be provided from the server 16.

The transceiver 18 receives the content and GUI customisation data URIs and in response to reception of the content URI, the server transmits a web page via the high-power transceiver 18, the web page listing current special offers at the supermarket. The web page is received by the telephone and is stored in the memory. In response to reception of the GUI customisation data URI, the server transmits GUI customisation data including text, graphics and audio data. The microprocessor generates an icon from the text and graphics data, which is displayed in the GUI. The user of the telephone selects the icon and the microprocessor generates an audio signal from the audio data stored in the memory, and executes the browser program so as to display the web page on the screen 30. The audio signal is a musical jingle used in advertising the supermarket on radio and television.

Retrieval of subsequent web pages is as described in respect of the default mode of the telephone, since a web page may contain a multitude of embedded content URIs, and preloading the web pages or data specified by each of those content URIs, of which only a few, if any, may be of interest to the user of the telephone, as occurs in the selectable mode, would be highly extravagant.

The above process is shown as a flow diagram in FIGS. 4A and 4B.

Returning to FIGS. 1 and 2, the GPS receiver 35 of the telephone periodically receives location data in a manner well understood in the field of positioning systems. The location data are periodically transmitted by the high-power transceiver 42 of the telephone to the transceiver 18, from which the location data is transmitted via the mobile telephone network to the mobile telephone service operator 17.

The mobile telephone service operator 17 acts on behalf of a large number of subscriber enterprises, which number includes the restaurant 25. Each such enterprise provides the mobile telephone service operator with boundary data which specify a geographical area in the vicinity of the enterprise.

Upon receiving location data from the telephone 10, the mobile telephone service operator determines whether the location data indicate that the telephone is within a geographical area specified by the boundary data of one of the subscriber enterprises.

The location data transmitted by the telephone indicate that the telephone is within the geographical area specified by the boundary data provided by the restaurant 25. The mobile telephone service operator therefore transmits an rf signal via the mobile telephone network and high-power transceiver 18 to the telephone, the rf signal including a user preference data word, content URI, GUI customisation data and boundary data. The user preference data word is used by the processor of the telephone to generate a user interest value associated with the content URI. If the user interest value exceeds the user interest threshold value stored in the telephone an icon representative of the restaurant is generated from the GUI customisation data and included in the GUI. Whether or not the content URI is transmitted to the server 16 by the telephone before the icon is selected is determined by whether the telephone is operating in the default or selectable mode. There is no transceiver status bit associated with the content URI, since once the user preference data word, content URI, GUI customisation data and boundary data have been acknowledged by the telephone, the mobile telephone service operator does not retransmit the rf signal to the telephone.

Each time the GPS receiver of the telephone receives location data, it compares the location data with the boundary data received from the mobile telephone service operator, which boundary data are identical with those provided to the mobile telephone service operator by the restaurant 25.

If the location data indicate that the telephone is no longer in the geographical area specified by the boundary data, and the icon has not been selected by the user of the device, the user preference data word, content URI, GUI customisation data and boundary data are deleted from the memory of the telephone.

FIGS. 5A and 5B illustrate the GUI 44 of the telephone 10. The GUI comprises a HOME page, REMOTE page and LOCAL INFO page, each identified by a respective tab 46, 48 and 50. The pages are displayed by selecting their respective tabs using the touch-sensitive screen.

In FIG. 5A the HOME tab has been selected and the HOME page is displayed. In FIG. 5B the LOCAL INFO tab has been selected and the LOCAL INFO page is displayed. The LOCAL INFO page includes icons 52, 54, 55 and 56. Icons 52, 54 and 55 represent, respectively, the museum 22, supermarket 24 and restaurant 25. The icon 56 indicates that the telephone is operating in the default mode. Hence selection of icon 52, 54 or 55 will cause the content URI specifying the location on the server of content relating to the museum, supermarket or restaurant respectively, to be transmitted by the high-power transceiver of the telephone. Selection of the icon 56 would cause the telephone to enter the selectable mode, and the icon 56 would change accordingly.

It will be apparent that the foregoing description relates only to one embodiment of the invention, and that the invention encompasses other embodiments as defined by the claims set out hereafter.

1. a wireless communication device that has generating means operable to generate a graphical user interface (GUI) comprising a plurality of frames, of which at least one frame contains a selectable image element, the device also having a display screen operable to display a frame of the GUI, and input means operable by a user of the device to select a selectable image element from a frame displayed by the display screen, the device being adapted to receive a radio frequency (rf) signal containing a content uniform resource identifier (content URI) specifying a location of content on a server of an internet content provider, and being operable to transmit the content URI to the server via a mobile telephone network, and to receive the content, which is transmitted by the server via the mobile telephone network in response to receipt of the content URI, the generating means being operable, in response to reception by the device of the rf signal containing the content URI, to generate a GUI of which one of the frames includes a selectable image element representative of the internet content provider, characterised in that the device is adapted to receive the rf signal containing the content URI from a short-range rf transmitter operating in accordance with the bluetooth specification.

2. A device according to claim 1, wherein the device is operable, in response to selection of the selectable image element representative of the Internet content provider, to transmit the content URI to the server and to display at least a portion of the content on the display screen.

3. A device according to claim 1, wherein the device is operable, in response to reception of the rf signal containing the content URI, to transmit the content URI to the server, and in response to selection of the selectable image element representative of the Internet content provider, to display at least a portion of the content on the display screen.

4. A device according to claim 1, wherein the device has location means operable to determine a geographical location of the device, and the device is operable periodically to transmit location data specifying a geographical location of the device via the mobile telephone network to a mobile telephone service operator, and to receive a content URI specifying a location of content on a server of an Internet content provider, which is transmitted via the mobile telephone network by the mobile telephone service operator if the location data indicate that the geographical location of the device is within a particular geographical area.

5. A device according to claim 1, wherein the device is adapted to receive content from the server in the form of web pages, and has browser means operable to browse the web pages.

6. A device according to claim 1, wherein the device has loudspeaker means and is operable to cause the loudspeaker means to generate an audio signal from at least a portion of the content.

7. A device according to claim 6, wherein the device is adapted to receive an rf signal containing GUI customisation data associated with the content URI, the GUI customisation data comprising one or more of graphics data, text data, audio data, HTML script, boundary data specifying a geographical area, and executable code.

8. A device according to claim 1, wherein the device is adapted to receive an rf signal containing a GUI customisation data URI specifying a location of GUI customisation data on the server, the GUI customisation data being associated with the content URI and comprising one or more of graphics data, text data, audio data, HTML script, boundary data specifying a geographical area, and executable code, to transmit the GUI customisation data URI to the server via the mobile telephone network, and to receive GUI customisation data transmitted by the server in response to reception of the GUI customisation data URI.

9. A device according to claim 7, wherein the generating means is operable to generate a GUI that includes the graphics and/or text data.

10. A device according to claim 9, wherein the generating means is operable to generate a GUI of which the selectable image element representative of the Internet content provider includes at least a portion of the graphics data and/or text data.

11. A device according to claim 7, wherein the device is operable to cause the loudspeaker means to generate an audio signal from the audio data.

12. A device according to claim 7, wherein the input means includes a softkey and the device is operable to modify the function of the softkey in accordance with at least a portion of the HTML script.

13. A device according to claim 7, wherein the device has processing means operable to execute the executable code.

14. A device according to claim 1, wherein the device is adapted to receive an rf signal containing user preference data associated with the content URI, to compare the user preference data with a user preference profile stored in the device, to generate a user interest value associated with the content URI, and to cause the generating means to generate the GUI that includes the selectable image element representative of the Internet content provider only if the user interest value exceeds a threshold value stored in the device.

15. A device according to claim 1, wherein the device is operable to cause the generating means to remove the selectable image element representative of the Internet content provider from the GUI and to discard the content URI and to carry out any of the following actions: cause the generating means to remove the graphics and/or text data from the GUI and to discard the GUI customisation data URI, GUI customisation data. and/or user interest value associated with the content URI in response to any of the following: when a time elapsed since the device received the rf signal containing the content URI exceeds a threshold value, when the location means determines that the device is in a geographic area outside that specified by the boundary data, when the user interest value associated with the content URI is less than at least one other user interest value associated with another content URI, and when a selectable image element representative of an instruction to delete the content URI is selected.

16. A device according to claim 4, wherein the device is operable to cause the generating means to remove the selectable image element representative of the Internet content provider from the GUI and to discard the content URI and to carry out any of the following actions: cause the generating means to remove the graphics and/or text data from the GUI and to discard the GUI customisation data URI, GUI customisation data and/or user interest value associated with the content URI in response to reception of an rf signal containing a delete instruction transmitted via the mobile telephone network by the mobile telephone network operator if the location data indicate that the geographical location of the device is outside a particular geographical area.

17. A computer program executable by a wireless communication device, the program comprising instructions to cause the device to generate a GUI comprising a plurality of frames and to display one of the frames, to cause the device to determine whether an rf signal received by the device contains a content URI specifying a location of content on a server of an Internet content provider, and to transmit the content URI via a mobile telephone network to the server, the program further comprising instructions to cause the device to generate a GUI of which one of the frames includes a selectable image element representative of the Internet content provider, characterised in that the program further comprises instructions to cause the device to determine whether an rf signal received by the device contains user preference data associated with the content URI, to cause the device to compare the user preference data with a user preference profile stored in the device, generate a user interest value associated with the content URI, and to cause the device to generate the GUI that includes the selectable image element representative of the Internet content provider only if the user interest value exceeds a threshold value stored in the device.

18. A program according to claim 17, wherein the program further comprises instructions to cause the device, in response to selection of the selectable image element representative of the Internet content provider, to transmit the content URI to the server and to display at least a portion of content transmitted to the device via the mobile telephone network by the server in response to reception of the content URI.

19. A program according to claim 17, wherein the program further comprises instructions to cause the device to transmit the content URI in response to receipt of the rf signal containing the content URI and, in response to selection of the selectable image element representative of the Internet content provider, to display at least a portion of content transmitted to the device via the mobile telephone network by the server in response to reception of the content URI.

20. A program according to claim 17, wherein the program further comprises instructions to cause the device periodically to transmit location data specifying a geographical location of the device via the mobile telephone network to a mobile telephone service operator, and to determine whether an rf signal, which is transmitted via the mobile telephone network by the mobile telephone service operator, contains a content URI.

21. A program according to claim 17, wherein the program further comprises instructions to cause the device to determine whether an rf signal received by the device contains GUI customisation data associated with the content URI, the GUI customisation data comprising one or more of graphics data, text data, audio data, HTML script, boundary data specifying a geographical area, and executable code.

22. A program according to 17, wherein the program further comprises instructions to cause the device to determine whether an rf signal received by the device contains a GUI customisation data URI specifying a location on the server of GUI customisation data associated with the content URI, the GUI customisation data comprising one or more of graphics data, text data, audio data, HTML script, boundary data specifying a geographical area, and executable code, and to cause the device to transmit the GUI customisation data URI to the server via the mobile telephone network.

23. A program according to claim 21, wherein the program further comprises instructions to cause the device to generate a GUI that includes graphics and/or text data transmitted to the device by the server in response to reception of the GUI customisation data URI.

24. A program according to claim 23, wherein the program further comprises instructions to cause the device to generate a GUI of which the selectable image element representative of the Internet content provider includes at least a portion of the graphics and/or text data.

25. A program according to claim 21, wherein the program further comprises instructions to cause the device to modify the function of a softkey in accordance with at least a portion of HTML script transmitted to the device by the server in response to reception of the GUI customisation data URI.

26. A program according to claim 21, wherein the program further comprises instructions to cause the device to execute executable code transmitted to the device by the server in response to reception of the GUI customisation data URI.

27. A program according to claim 17, wherein the program further comprises instructions to cause the device to remove the selectable image element representative of the Internet content provider from the GUI, to discard the content GUI and to carry out any of the following actions: cause the device to remove the graphics and/or text data from the GUI and to discard the GUI customisation data URI, GUI customisation data and/or user interest value associated with the content URI in response to any of the following: when a time elapsed since the device received the rf signal containing the content GUI exceeds a threshold value, when the location means determines that the device is in a geographic location outside the geographic area specified by the boundary data, when the user interest value associated with the content URI is less than at least one other user interest value associated with another URI, and when a selectable image element representative of an instruction to delete the URI is selected.

28. A program according to claim 20, wherein the program further comprises instructions to cause the device to remove the selectable image element representative of the Internet content provider from the GUI, to discard the content URI and to carry out any of the following actions: cause the device to remove the graphics and/or text data from the GUI and discard the GUI customisation data URI, GUI customisation data and/or user interest value associated with the content URI in response to reception by the device of a delete instruction transmitted via the mobile telephone network by the mobile telephone service operator.

29. A program according to 17, when stored on a data carrier.

30. A wireless communication device in which is stored a computer program in accordance with claim 17.

31. (Canceled)

32. (Canceled)
